(19) United States
(12) Patent Application Publication
(10) Pub. No.: US 2025/0289256 A1
(43) Pub. Date: Sep. 18, 2025

(54) PREHEATING PERSONALIZED IDENTIFICATION DOCUMENTS PRIOR TO PRINTING

(71) Applicant: ENTRUST CORPORATION, Shakopee, MN (US)

(72) Inventors: PETER SCHMIDT, Shakopee, MN (US); JON WAWRA, Shakopee, MN (US); RYAN SCHWIDERSKI, Shakopee, MN (US); BRENDAN HINNENKAMP, Shakopee, MN (US)

(21) Appl. No.: 19/079,048

(22) Filed: Mar. 13, 2025

Related U.S. Application Data
(60) Provisional application No. 63/565,273, filed on Mar. 14, 2024.

(51) Int. Cl. B41M 5/00; B41J 3/407; B41J 11/00; B41J 29/377; B41M 3/00; B41M 7/00

(52) U.S. Cl. CPC B41M 5/0011; B41J 3/407; B41J 11/00214; B41J 29/377; B41M 3/005; B41M 5/0064; B41M 7/0081

(57) ABSTRACT

Techniques are described for applying heat to a personalized identification document to increase the temperature of a portion of a surface of the document prior to printing on the surface. Applying heat to the document substrate improves one or more qualities such as the adhesion, quality, and/or durability of printing that is subsequently applied to the surface, reduces the printhead voltage used during printing (in the case of thermal transfer printing), is less costly and is easier to implement than creating heat in the substrate for example using plasma treatment.

### RELATED APPLICATION

This application claims the benefit of U.S. Provisional Application No. 63/565,273, filed Mar. 14, 2024, the disclosure of which is incorporated herein by reference.

### FIELD

This technical disclosure relates to printing on personalized identification documents such as personalized identification cards including, but not limited to, financial (e.g., credit, debit, or the like) cards, access cards, driver's licenses, national identification cards, passport cards, and business identification cards, and other personalized identification cards, as well as passports and pages of passports.

### BACKGROUND

The printing that is applied to a personalized identification document should be long lasting so that the holder of the personalized identification document can use the document for a long period of time. When printing on some personalized identification documents, adhesion of the printing to the substrate is challenged by use cases, such as use of the documents in harsh environments, or by substrate differences. In some instances, it has been found that increasing the printhead voltage during printing (in the case of thermal transfer printing) or pre-treating the document surface with a plasma prior to printing (in the case of drop-on-demand printing) has been found to increase adhesion of the printing to the substrate. In the case of plasma treatment, the application of the plasma to the substrate causes the substrate to heat up. However, there are disadvantages to these methods including higher cost and decreased printhead life.

### SUMMARY

Techniques are described for applying heat to a personalized identification document to increase the temperature of a portion of a surface of the document prior to printing on the surface. Applicant has discovered that applying heat to the document substrate improves the adhesion of printing that is subsequently applied to the surface, improves print quality, improves durability of the printing, reduces the printhead voltage used during printing (in the case of thermal transfer printing), extends printhead life, is less costly and is easier to implement than creating heat in the substrate for example using plasma treatment.

The heat can be applied using a heat mechanism that is configured to create heat and direct the heat toward a surface of the personalized identification document. For example, the heat mechanism may be a heat gun that directs a flow of heated air toward the document or a radiant heat source. The entire surface of the document may be heated or only a portion(s) of the surface may be heated.

In one example described herein, a method of printing on a personalized identification document in a document personalization system can include inputting the personalized identification document into the document personalization system, applying heat to at least a portion of a first surface of the input personalized identification document to heat the portion of the first surface, and thereafter applying printing to the heated portion of the first surface using a print mechanism of the document personalization system.

In another example described herein, a method of improving one or more qualities such as adhesion, print quality, and/or durability of printing on a personalized identification document in a document personalization system can include inputting the personalized identification document into the document personalization system, transporting the input personalized identification document to a location in the document personalization system, and then at the location applying heat to at least a portion of a surface of the input personalized identification document to heat the portion of the surface. Thereafter, the heated portion of the surface may be printed on using radiation curable ink in a print mechanism of the document personalization system. Thereafter, the input personalized identification document is transported to a location where radiation is applied to cure the radiation curable ink.

In another example described herein, a document personalization system can include a document input that is configured to hold a plurality of personalized identification documents to be personalized, and a document output that is configured to hold a plurality of personalized identification documents after being personalized. In addition, a print mechanism may be located downstream of the document input, with the print mechanism configured to print on a surface of a personalized identification document input from the document input. In addition, a heat mechanism may be located between the document input and the print mechanism, with the heat mechanism configured to apply heat to at least a portion of the surface of the input personalized identification document to heat the portion of the surface prior to printing in the print mechanism.

### DRAWINGS

FIG. 1 illustrates an example of a method of printing on a personalized identification document in a document personalization system described herein.

FIG. 2 illustrates another example of a method of printing on a personalized identification document in a document personalization system described herein.

FIG. 3 schematically illustrates an example of a document personalization system that can implement a method described herein.

FIG. 4 schematically illustrates another example of a document personalization system that can implement a method described herein.

FIG. 5 schematically illustrates another example of a document personalization system that can implement a method described herein.

FIG. 6 schematically illustrates another example of a document personalization system that can implement a method described herein.

FIG. 7 schematically depicts a heat mechanism directing heat toward a surface of a personalized identification document prior to printing on the surface.

FIGS. 8A and 8B illustrate a first surface and a second, respectively, of a personalized identification document that has been printed on using the techniques described herein.

### DETAILED DESCRIPTION

The following is a detailed description of improving one or more print qualities such as the adhesion, quality, and/or durability of printing that is applied to a surface of a personalized identification document by applying heat to some or all of a surface of the personalized identification document to increase the temperature of the surface prior to printing on the surface. Applying heat to the surface differs from causing the surface to heat up, for example which is the case during plasma treatment. Applying heat from a heat mechanism is less costly and is easier to implement than creating heat in the substrate, for example using plasma treatment which is a secondary effect of the plasma treatment. Printhead life is also extended.

As used herein, a personalized identification document refers to a document that is intended to be personalized with data that is specific to (or unique to or assigned to) the intended document holder. In the document personalization industry, the term personalized identification document is often used to refer to a document prior to having any personalization applied to the document, as well as to a document after having personalization applied. The personalized data may include one or more of a printed portrait image of the intended document holder, the printed name of the intended document holder, and printed account information such as account number, expiration date and the like.

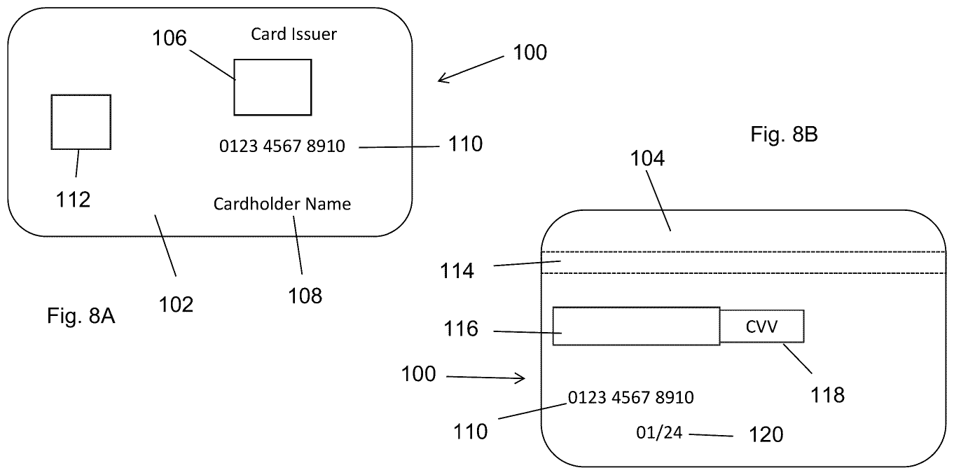

Personalized identification documents encompassed by the techniques described herein include personalized identification cards such as financial (e.g., credit, debit, or the like) cards, access cards, driver's licenses, national identification cards, passport cards, and business identification cards, and other personalized identification cards, as well as passports and pages of passports. An example of a personalized identification document in the form of a card is described below and illustrated in FIGS. 8A and 8B.

In an embodiment, the personalized identification documents may be plastic cards or non-plastic cards. In an embodiment, the cards may be ID-1 cards as defined by ISO/IEC 7810. However, other card formats such as ID-2 as defined by ISO/IEC 7810 are possible as well. In one embodiment, the card can be sized to comply with ISO/IEC 7810 with dimensions of about 85.60 by about 53.98 millimeters (about 3⅜ in×about 2⅛ in) and rounded corners with a radius of about 2.88-3.48 mm (about ⅛ in). The printing can also occur on pages, such as plastic pages, of passports as well. The passport pages can be a front cover or a rear cover of the passport, or an internal page (for example a page referred to as a data page) of the passport. In an embodiment, the passports may be in an ID-3 format as defined by ISO/IEC 7810.

The term personalized identification documents, unless indicated otherwise, refers to documents where the document substrate can be formed entirely of a material such as plastic, or formed of a combination of materials such as plastic and non-plastic materials. As would be understood by a person of ordinary skill in the art, personalized identification documents in the form of cards are typically formed of multiple individual layers that form the majority of the card body or the card substrate. Similarly, the term “page” of a passport refers to passport pages where the passport can be formed entirely of a material such as plastic, or formed of a combination of materials such as plastic and non-plastic materials. An example of a passport page is the data page in a passport containing the personal data of the intended passport holder. The passport page may be a single layer or composed of multiple layers. In the case of a plastic card, examples of plastic materials that the card (or passport page), or the individual layers of the card or passport can be formed from include, but are not limited to, polycarbonate, polyvinyl chloride (PVC), polyester, acrylonitrile butadiene styrene (ABS), polyethylene terephthalate glycol (PETG), TESLIN® combinations thereof, and other plastics.

Unless indicated by the Applicant to the contrary, the word “step” as used herein and in the claims is intended to cover a single act or action, or a plurality of acts or actions that form the step.

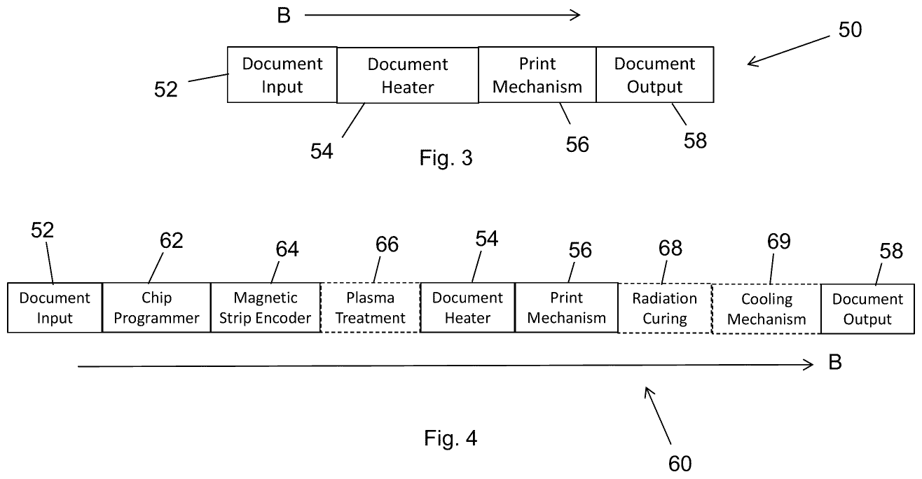

Referring initially to FIG. 1, a method 10 of printing on a personalized identification document in a document personalization system is depicted. In the method 10, in step 12 a personalized identification document is input into the document personalization system. The document may be mechanically input from an input hopper that holds a plurality of the documents waiting to be personalized. In another embodiment, the document may be manually input, for example manually fed into an input slot of the document personalization system. Examples of document personalization systems that can be used to implement the method 10 are described below and illustrated in FIGS. 3-6.

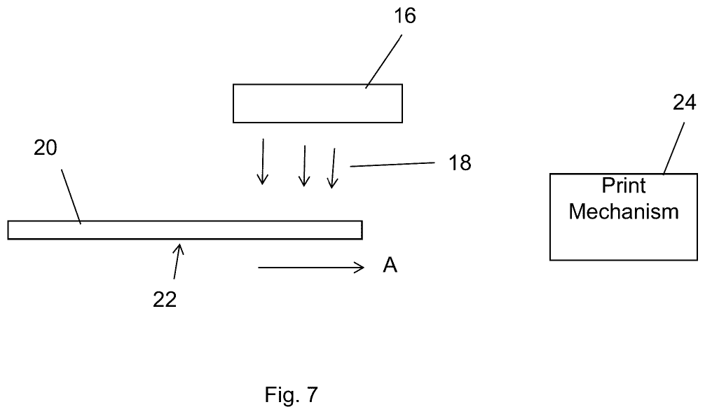

With continued reference to FIG. 1, in step 14 heat is applied to the surface of the document to heat the surface. The heat may be applied to the entire surface of the document to heat the entire surface. In another embodiment, heat may be applied to a portion of the document surface (i.e. local heating) to heat only that portion of the surface. The heat can be applied using any heat mechanism in the document personalization system that is suitable for generating heat and directing the heat toward the document surface. For example, referring to FIG. 7, a heat mechanism 16, which may be a heat gun, a radiant heat source or other device suitable for applying heat to the document, is depicted directing heat 18 toward a surface 20 of a personalized identification document 22. In the example depicted in FIG. 7, the heat mechanism 16 is depicted as being located above a travel path of the document 22 and upstream of a print mechanism 24 that will perform printing on the resulting heated surface. The heat mechanism 16 may be located immediately upstream of the print mechanism 24, or one or more document processing mechanisms may be located between the location of the heat mechanism 16 and the print mechanism 24. In an embodiment, the heat mechanism 16 may be incorporated into and be considered part of the print mechanism 24. The heat mechanism 16 may be located anywhere in the document personalization system that is suitable for applying heat to the document surface to heat the document surface prior to printing on the document surface. The surface 20 may be heated while the document 22 is stationary or, as depicted by the arrow A, the surface 20 may be heated while the document 22 is moving and being transported toward the print mechanism 24.

The amount of heat that is applied to the surface may depend on a number of factors such as the type of material forming the document surface, the type of printing that is performed by the print mechanism, the type of ink used by the print mechanism, the amount of time between heating and printing on the surface, and any processing that occurs on the surface prior to applying the heat. For example, in the case of a plastic card where at least the surface to be printed on is formed of polycarbonate, and the print mechanism performs drop-on-demand (DOD) printing using radiation curable ink, for example ultraviolet (UV) curable ink, Applicant has found that heating the surface to the be printed on to a temperature of between about 55-60° C. prior to printing has achieved acceptable results.

Returning to FIG. 1, after the surface of the document has been heated, printing is performed on the heated surface in step 26. The printing can be performed using the print mechanism 24 (depicted in FIG. 7) which can be located downstream of the heat mechanism 16, upstream of the heat mechanism 16, or at any other location in the document personalization system relative to the heat mechanism 16. The printing that is performed in step 26 can be DOD printing, thermal transfer printing using a thermal printhead and a print ribbon, retransfer printing, or any other type of printing known in document personalization systems. The ink that is applied during printing may be a UV or other radiation curable ink, or non-UV/radiation curable ink. In the case of UV curable ink, after printing in step 26 UV radiation is applied to the document surface to cure the applied ink. In an embodiment, the printing in step 26 may include the printing of a varnish or topcoat onto the surface which may or may not overlap other printing applied to the surface by the print mechanism 24. The varnish or topcoat may be a UV or other radiation curable material, or a non-UV/radiation curable material.

The printing in step 26 may apply one or more of a printed portrait image of the intended document holder, the printed name of the intended document holder, printed account information such as an account number assigned to the intended document holder, and other data personal to the intended document holder. The printing may be multi-color, for example using cyan, magenta, yellow and black (CMYK), monochromatic, or one or more specialty colors.

FIGS. 8A and 8B illustrate an example of a personalized identification document 100 in the form of a personalized card that has been printed using the techniques described herein. In this example, the document 100 is shown to include a front or first surface 102 (FIG. 8A) and a rear, back or second surface 104 (FIG. 8B) opposite the front surface 102. The document 100 may be printed on one side only (referred to as simplex printing), for example on the front surface 102 or the rear surface 104, or printed on both sides (referred to as duplex printing), for example on each of the front surface 102 and the rear surface 104.

In the illustrated example in FIG. 8A, the front surface 102 can include various printed data such as a printed portrait image 106, the cardholder/document holder name 108, and account information such as an account number 110, expiration date and the like. The front surface 102 can also include other printed data such as printed information of the entity that issued the card, such as the corporate name and/or logo of the issuing bank (for example, STATE BANK), and/or printed information of the card brand name (for example, VISA®, MASTERCARD®, DISCOVER®, etc.). The document 100 may also include a contact (or contactless) integrated circuit chip 112 that can store various data relating to the card and/or the cardholder such as an account number and/or name of the cardholder.

Referring to FIG. 8B, the rear surface 104 can include a magnetic strip 114 that stores various data relating to the document 100 such as an account number or name of the cardholder, a signature panel 116 that provides a place for the cardholder to sign their name, a Card Verification Value (CVV) panel 118, and a hologram. The magnetic strip 114, the signature panel 116, the CVV panel 118 and the hologram are conventional elements found on many cards. The rear surface 104 can also include printed personal data that is unique to or assigned specifically to the cardholder. For example, the account number 110 assigned to the cardholder, the name of the cardholder, and a card expiration date 120 can be printed on the rear surface 104. Other personal cardholder data may also be printed on the rear surface 104, such as an image of the face of the cardholder. Non-personal data such as the name of the issuing bank, contact information to contact the issuing bank, and the like, can also be printed on the rear surface 104.

Returning to FIG. 1, after printing in step 26, the now printed document can then be output in step 28. In step 28, the document can be output into an output hopper that is configured to hold a plurality of printed documents. In another embodiment, the document can be output from an output slot directly to a user.

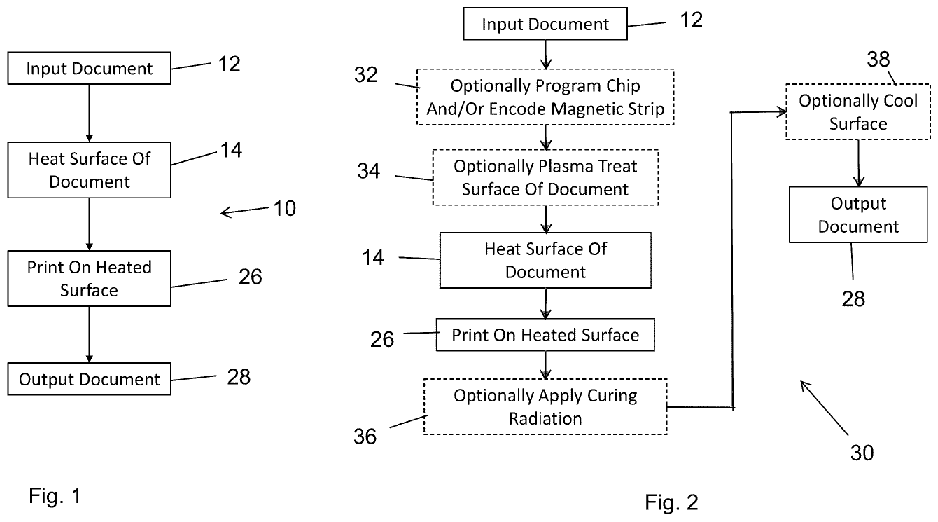

Between steps 12 and 14, one or more additional document processing steps can be performed as will be described further below. For example, referring to FIG. 2, another embodiment of a method 30 of printing on a personalized identification document in a document personalization system is depicted. In the method 30, steps that are the same as or similar to steps in the method in FIG. 1 are referenced using the same reference numbers. In the method 30, FIG. 2 depicts that between steps 12 and 14, a step 32 may optionally be performed where the programmable chip on the document may be programmed with data (or simply tested to determine if the chip properly functions) and/or the magnetic strip on the document may be magnetically encoded with data. In another embodiment, a step 34 may optionally be performed where the surface of the document to the printed on is plasma treated. Steps 32 and 34 may be individually performed or performed together.

In another embodiment, between steps 14 and 26 of FIG. 1, one or more additional document processing steps can be performed. For example, after heating the surface, the document can be “parked” for a period of time prior to printing to allow the surface of the document to cool down to a more desired temperature prior to printing. Cooling can be achieved passively or actively by directing a flow of cooling air from a cooling fan over the heated surface.

In another embodiment, between steps 26 and 28 of FIG. 1, one or more additional document processing steps can be performed. For example, referring to FIG. 2, the method 30 depicts that between steps 26 and 28, a step 36 may optionally be performed where curing radiation is applied to the surface to cure radiation curable material that was printed on the surface. In another embodiment, a step 38 may optionally be performed where the surface of the document is allowed to cool. Cooling can be achieved passively or actively by directing a flow of cooling air from a cooling fan over the heated surface. Steps 36 and 38 may be individually performed or performed together. If performed together, step 38 may be performed prior to step 36. Other processing steps may be performed between steps 26 and 28 including, but not limited to, embossing characters on the document; indenting characters on the document; applying a laminate to the document; using a laser to laser mark the document; applying a topcoat to the document; applying a security feature such as a holographic foil patch to the document; performing a quality check of the document using a vision system; and other document processing operations.

FIG. 3 schematically depicts an example of a document personalization system 50 that can implement a method, such as the method of FIG. 1, described herein. In this example, the system 50 is depicted as including a document input 52, a document heater 54, a print mechanism 56, and a document output 58. However, the system 50 may include additional mechanisms as well.

The document input 52 may be an input slot through which a single document is fed, often manually, or an input hopper that is configured to hold a plurality of documents waiting to be processed and feed the documents one-by-one for processing. Documents are fed one-by-one from the document input 52 into the rest of the system 50 where each document is individually processed and transported in the system 50 in the direction of the arrow B.

The document heater 54 can comprise, as described above, any heat mechanism in the system 50 that is suitable for generating heat and directing the heat toward the document surface. For example, the heat mechanism may be a heat gun, a radiant heat source or other device suitable for applying heat to the document surface.

The print mechanism 56 can comprise, as described above, a DOD print mechanism with one or more DOD printheads, a thermal transfer print mechanism that includes one or more thermal printheads and a print ribbon associated with each printhead, a retransfer print mechanism that is configured to perform retransfer printing, or any other type of print mechanism known in document personalization systems. The ink that is applied by the print mechanism 56 may be a UV or other radiation curable ink, or non-UV/radiation curable ink. In the case of UV curable ink, after printing UV radiation is applied to the document surface to cure the applied ink. In an embodiment, the print mechanism 56 may be configured to print a varnish or topcoat onto the document surface which may or may not overlap other printing applied to the surface by the print mechanism 56. The varnish or topcoat may be a UV or other radiation curable material, or a non-UV/radiation curable material.

The document output 58 may be an output slot or a hopper that is configured to hold a plurality of personalized documents. FIG. 3 depicts that the output 58 may be located at the end of the system 50 opposite the input 52. However, the input 52 and the output 58 may be located at the same end of the system 50, or the input 52 and the output 58 can have other relative positioning to one another.

FIG. 4 schematically depicts another example of a document personalization system 60 that can implement a method, such as the methods of FIGS. 1 and 2, described herein. In the system 50, elements that are the same as or similar to elements in the system 50 in FIG. 3 are referenced using the same reference numbers. In this example, the system 50 is depicted as including the document input 52, the document heater 54, the print mechanism 56, and the document output 58. The system 50 may further include an optional chip programmer 62 (or chip programming module or chip programming station) that may include one or more chip programming heads for programming the chip of a single document at any time, or include a plurality of chip programming heads for simultaneous programming of chips of a plurality of documents; an optional magnetic strip encoder 64 (or a magnetic strip read/write system or magnetic strip module) that is configured to read data from and/or encode data on a magnetic strip on each document (either one at a time or simultaneous encoding of magnetic strips on a plurality of documents); an optional plasma treatment mechanism 66 that is configured to plasma treat at least a portion of a surface of a document; and an optional radiation curing mechanism 68 that is configured with at least one radiation generator for applying curing radiation to radiation curable material printed on the document surface by the print mechanism 56. If cooling of the document surface after printing is desired, a cooling mechanism 69, such as a cooling fan, may be provided in the system 60, for example between the print mechanism 56 and the radiation curing mechanism 68, or between the radiation curing mechanism 68 and the document output 58.

The systems 50, 60 in FIGS. 3 and 4 may be configured as large volume batch production document personalization systems (sometimes referred to as a central issuance personalization system). A large volume batch production document personalization system is configured to process multiple documents, such as cards or passports at the same time, with the documents being processed in sequence, with the documents proceeding generally along a document transport direction/transport path. A large volume batch production document personalization system typically processes documents in high volumes, for example on the order of high hundreds or thousands per hour, and employs multiple processing stations or modules to process multiple documents at the same time to reduce the overall per document processing time. Examples of such large volume document personalization machines include the MX and MPR family of central issuance personalization machines available from Entrust Corporation of Shakopee, Minnesota. Other examples of central issuance personalization machines are disclosed in U.S. Pat. Nos. 4,825,054, 5,266,781, 6,783,067, 6,902,107, and 10,049,320 all of which are incorporated herein by reference in their entirety.

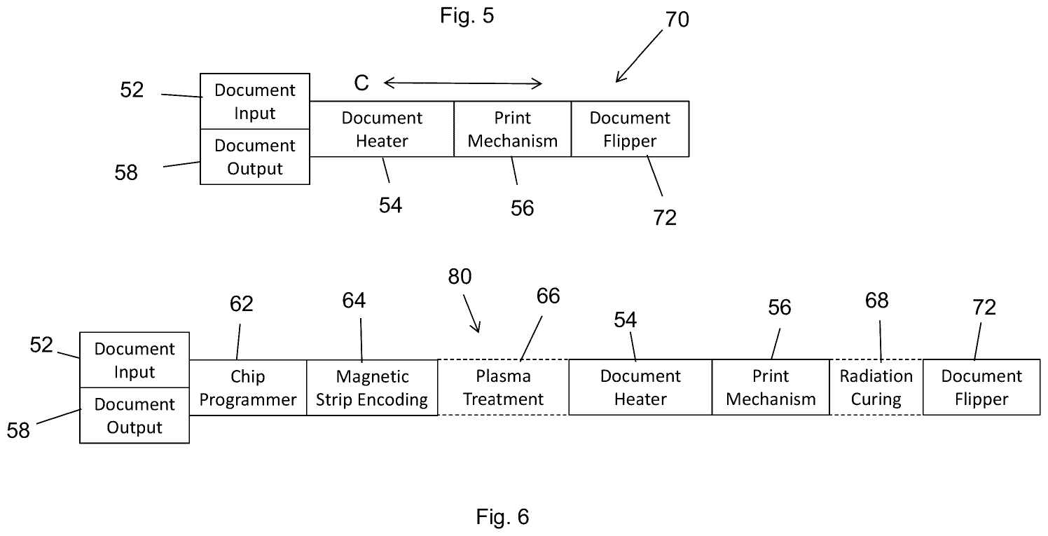

FIG. 5 schematically depicts another example of a document personalization system 70 that can implement a method, such as the method of FIG. 1 described herein. In the system 70, elements that are the same as or similar to elements in the systems 50, 60 in FIGS. 3 and 4 are referenced using the same reference numbers.

In this example, the system 70 is depicted as including the document input 52, the document heater 54, the print mechanism 56, and the document output 58. In this example, the document input 52 and the document output 58 are located at the same end of the system 70. The system 70 may further include a document flipper 72 that is configured to flip a document 180 degrees after being printed in the print mechanism 56 with the document then being directed back into the print mechanism 56 and possibly even back into the document heater 54 to apply heat to the opposite surface of the document for two-sided or duplex printing on the document. If the document is directed back into the document heater 54 to heat the opposite surface, the opposite surface may be heated more than, less than, or the same as the first surface. In the system 70, the document is transported in the system 70 in the direction of the arrow C in both forward (i.e. away from the document input 52) and reverse (i.e. toward the document input 52) directions.

FIG. 6 schematically depicts still another example of a document personalization system 80 that can implement a method, such as the methods of FIGS. 1 and 2, described herein. In the system 80, elements that are the same as or similar to elements in the systems 50, 60, 70 in FIGS. 3-5 are referenced using the same reference numbers. In this example, the system 80 is depicted as including the document input 52, the document heater 54, the print mechanism 56, the document output 58, and the document flipper 72. In this example, the document input 52 and the document output 58 are located at the same end of the system 80 like in the system 70. In addition, the system 80 may further include the optional chip programmer 62 (or chip programming module or chip programming station); the optional magnetic strip encoder 64 (or a magnetic strip read/write system or magnetic strip module); the optional plasma treatment mechanism 66; and the optional radiation curing mechanism 68. If cooling of the document surface after printing is desired, a cooling mechanism (similar to the cooling mechanism 69 in FIG. 4) may be provided in the system 80, for example between the print mechanism 56 and the radiation curing mechanism 68, or between the radiation curing mechanism 68 and the document flipper 72.

The systems 70 and 80 in FIGS. 5-6 may be configured as desktop document personalization systems. A desktop document personalization system is typically designed for relatively smaller scale, individual document personalization in relatively small volumes, for example measured in tens or low hundreds per hour, often times with a single document being processed at any one time. These document personalization machines are often termed desktop personalization machines because they have a relatively small footprint intended to permit the machine to reside on a desktop. Many examples of desktop document personalization machines are known, such as the SIGMA™ and ARTISTA™ family of desktop card printers available from Entrust Corporation of Shakopee, Minnesota. Other examples of desktop document personalization machines are disclosed in U.S. Pat. Nos. 7,434,728 and 7,398,972, each of which is incorporated herein by reference in its entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of printing on a personalized identification document in a document personalization system, comprising:
inputting the personalized identification document into the document personalization system;
applying heat to at least a portion of a first surface of the input personalized identification document to heat the portion of the first surface;
thereafter printing on the heated portion of the first surface using a print mechanism of the document personalization system.

2. The method of claim 1, comprising applying heat to the entire first surface of the input personalized identification document to heat the entire first surface; and thereafter printing on at least a portion of the heated first surface.

3. The method of claim 1, wherein the personalized identification document comprises a plastic card, a non-plastic card, a passport, or a passport page.

4. The method of claim 1, wherein the print mechanism prints using radiation curable ink, and the printing on the heated portion of the first surface comprises the radiation curable ink.

5. The method of claim 4, comprising applying radiation to cure the radiation curable ink.

6. The method of claim 1, comprising applying the heat from a heat gun or from a radiant heat source.

7. The method of claim 1, wherein after printing on the heated portion of the first surface, actively cooling the heated portion of the first surface.

8. The method of claim 1, wherein the personalized identification document comprises polycarbonate, and heating the portion of the first surface to a temperature of 55-60° C.

9. The method of claim 1, wherein prior to applying the heat, plasma treating at least a portion of the first surface of the input personalized identification document.

10. The method of claim 1, further comprising:
after printing on the heated portion of the first surface, applying heat to at least a portion of a second surface of the input personalized identification document to heat the portion of the second surface;
thereafter printing on the heated portion of the second surface using the print mechanism of the document personalization system.

11. A method of improving one or more qualities of printing on a personalized identification document in a document personalization system, comprising:
inputting the personalized identification document into the document personalization system;
transporting the input personalized identification document to a location in the document personalization system and at the location applying heat to at least a portion of a surface of the input personalized identification document to heat the portion of the surface;
thereafter printing on the heated portion of the surface using radiation curable ink in a print mechanism of the document personalization system; and
thereafter transporting the input personalized identification document and applying radiation to cure the radiation curable ink.

12. The method of claim 11, comprising applying heat to the entire surface of the input personalized identification document to heat the entire surface; and thereafter printing on the surface using the radiation curable ink in the print mechanism.

13. The method of claim 11, wherein the personalized identification document comprises a plastic card, a non-plastic card, a passport, or a passport page.

14. The method of claim 11, comprising applying the heat from a heat gun or from a radiant heat source.

15. The method of claim 11, wherein after printing on the heated portion of the surface, actively cooling the heated portion of the surface.

16. The method of claim 11, wherein the personalized identification document includes a layer that forms the surface; the layer comprises polycarbonate; and comprising heating the portion of the surface to a temperature of 55-60° C.

17. The method of claim 11, wherein prior to applying the heat, plasma treating at least a portion of the surface of the input personalized identification document.

18. A document personalization system, comprising:
a document input that is configured to hold a plurality of personalized identification documents to be personalized;
a document output that is configured to hold a plurality of personalized identification documents after being personalized;
a print mechanism located downstream of the document input and configured to print on a surface of a personalized identification document input from the document input;
a heat mechanism that is configured to apply heat to at least a portion of the surface of the input personalized identification document to heat the portion of the surface prior to printing in the print mechanism.

19. The document personalization system of claim 18, wherein the print mechanism is configured to print using radiation curable ink; and further comprising a curing station that includes at least radiation emitting element that emits radiation to cure the radiation curable ink applied to the surface.

20. The document personalization system of claim 18, wherein the heat mechanism comprises a heat gun or radiant heat source.

21. The document personalization system of claim 18, further comprising a plasma treatment station that includes a plasma emitter.

22. The document personalization system of claim 18, further comprising a cooling fan that is positioned to direct a flow of cooling air onto the surface after printing.
